(19) United States
(12) Patent Application Publication
(10) Pub. No.: US 2013/0076584 A1
(43) Pub. Date: Mar. 28, 2013

(54) High Performance (mini-cube) Indoor HDTV Antenna

(71) Applicants: Gary Gwoon Wong, Torrance, CA (US); Calvin Gwoon Wong, Torrance, CA (US); Kalem Gwoon Wang, Torrance, CA (US)

(72) Inventors: Gary Gwoon Wong, Torrance, CA (US); Calvin Gwoon Wong, Torrance, CA (US); Kalem Gwoon Wang, Torrance, CA (US)

(21) Appl. No.: 13/573,495

(22) Filed: Sep. 19, 2012

Related U.S. Application Data
(60) Provisional application No. 61/626,291, filed on Sep. 26, 2011.

(51) Int. Cl. H01Q 13/02; H01P 11/00

(52) U.S. Cl. 343/786; 29/600

(57) ABSTRACT

This invention discloses a design and fabrication of a high performance compact antenna to receive public airwaves HDTV signals. The subject antenna consists of a high efficient cone shape broadband element excited over a small metal ground plane. A reflecting surface is implemented to help rejecting any unwanted multiple reflecting signals from the surrounding objects. Outstanding impedance characteristics and broad pattern coverage have been obtained. The pattern coverage is omnidirectional. The polarization is linear along the cone axis. This antenna design operates well in a weak signal environment and as a result the antenna can receive a large number of public channels. Although the antenna measures only 5¾×5¾×3¼ inches in a cubical enclosure or in a 6⅜ inches diameter by 3½ inches depth cylindrical body, the antenna packaged in either enclosure can receive more public channels than a much larger antenna twice of its size. Two invention antennas have been fabricated and tested and the test results confirmed that all antennas of either enclosure were performing well as expected. The invention antennas receive more than 130 public channels.

### CROSS-REFERENCE TO RELATED APPLICATION

This application claims the benefit of U.S. Provisional Application No. 61/626,291 filled on Sep. 26, 2011.

### FIELD

Present disclosure provides new arts in design and fabrication of antennas to receive public air wave signals specifically relating to television antenna.

### BACKGROUND

TV transmission in the past for the most part has always been in analog; high gain antennas were required. TV antennas were either Log Periodic or Yagi designs. These antennas are physically large and often require mounting on poles outside the house or building. Today, the HDTV signals are transmitted over UHF and occasionally VHF bands. Also the signals are digitized and spread over a wide band; only very low detectable signals are required for good reception. As a result, only low gain and broad coverage antennas are required for HDTV reception.

The antennas addressed in this disclosure are physically small, requiring no external power. The art of the design is broad band and proving good uniform coverage over the transmission band. These desirable features are evident in the invention antenna. Current antenna art lacks broad band performance and also lack of abilities to reduce inference signals from its surrounding objects.

### DRAWINGS

FIG. 1—Cone Element

FIG. 1 is a perspective view of one preferred embodiment of the subject invention containing a cone radiator 1 mounted on a metal ground plane 2 through the F (panel mounted) connector 3. The ground plane 2 is a square shape of 5½ inches which is designed to fit into the FIG. 2 enclosure. The ground plane can be round if the enclosure is designed to be round. The ground plane serves an important purpose; it produces an image effect to the cone element and allows it to radiate as a symmetrical structure. It also helps to reduce the size of the antenna.

FIG. 2—Cubical Enclosure

FIG. 2 is the perspective view of the antenna enclosure. It is an enclosure of cubical shape. The front and back surfaces of the enclosure are squares and the edge dimension 4 is 5¾ inches and the depth dimension 5 is 3¼ inches. Two of the side walls surfaces are covered by metal surfaces 5a.

The materials for forming the enclosure are Abs plastic sheets that are bonded together by a 4SC solvent. Other materials such as wood and numerous plastics may also be used for fabrication of this enclosure. Injection molding processes may also be employed.

FIG. 3—Cone Element In Cubical Enclosure

FIG. 3 is the prospective view of the cone radiating element packaged into the cubical enclosure. The cone diameter 6 is 5¼ inches and the cone angle 7 is 90 degrees.

FIG. 4—Cone Element in Cylindrical Enclosure

FIG. 4 is the prospective view of the cone element integrated into a cylindrical enclosure. The outer diameter 8 of the cylindrical enclosure is 6⅜ inches. The enclosure is made from commercially available PVC plastic pipe by cutting the pipe to dimension 9 of 3½ inches in length. The ends are enclosed by two circular PVC plastic pieces which are bonded to the enclosure body. A metal ground plane is bonded to the circular plastic piece where the F connector is connected. The base plate 10 is implemented by bonding a 3½×4 inches plastic piece directly onto the cylindrical body. All dimensions were selected to ensure the antenna performs well over the UHF band and some low frequencies that are associating with the HDTV receptions. Again, injection molding method may also be used to fabricate the cylindrical enclosure. Approximately one half of the inner cylindrical body surface is covered by a thin metal surface 11. This metal surface is bonded to the inner enclosure body. The surface is designed to shape the antenna pattern coverage in reducing multiple reflection effects from the surrounding objects.

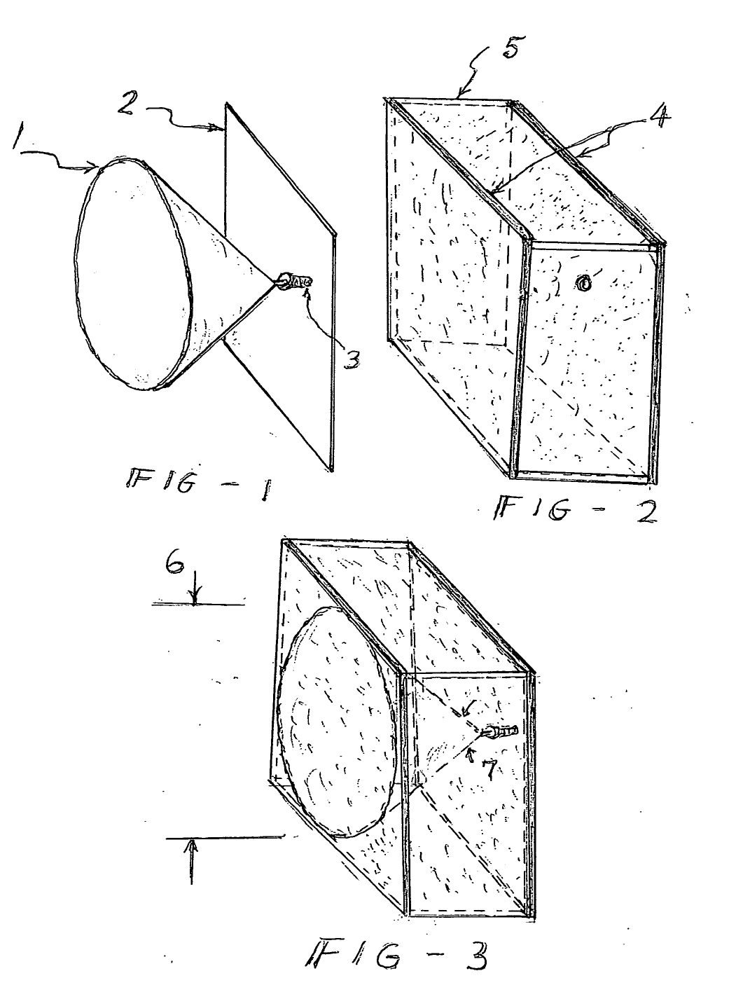

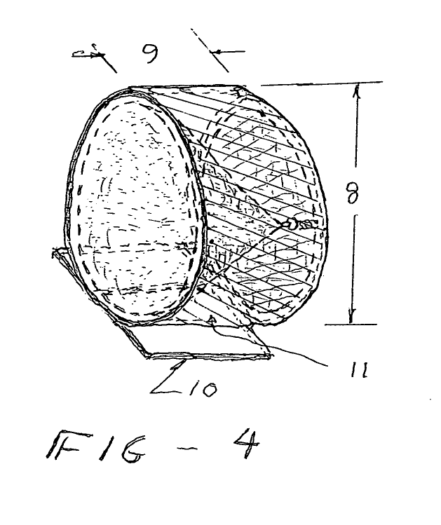

### DETAIL DESCRIPTION

The subject invention antenna consists of a unique cone shape high efficiency broad band element which is excited by a unique F connector through the antenna ground plane.

### Antenna Radiating Element Design

In our discussion of the operating theories, the antenna can be considered as a radiator or as a receiving element. The antenna performs identically in either mode. More often than not the antenna can be explained and understood as a transmitting device.

The radiating element is the most critical part of this invention. Rabbit ears, loops or dipoles radiators are the most commonly use in indoor antenna needs. These antennas are lacking of cost and performance efficiency advantages. What is needed then is a high performance antenna, compact in size, and easily manufactured. The invention antenna disclosed here has all these unique advantages. It is therefore an objective of the present invention to provide such a device.

The radiating element of this disclosure consists of a cone radiator and a ground plane. The cone radiator is positioned perpendicular to a small ground plane. The cone radiator is fabricated by forming the cone through joining the edges of a thin metal dish with a portion of the dish cut out. The cone diameter is 5 inches and the cone angle is 90 degrees.

There are many options that may be employed for fabrication of the cone radiator. Stamping or metal spraying over plastic cones may also be considered.

### Antenna Ground Plane

The ground plane enables the cone radiator to perform as a symmetrical structure. It helps eliminate the need of a balun (balanced-to-unbalanced converter). An F connector is connected directly to the cone without the use of a coaxial cable.

This invention provides an effective way and low cost in implementing the indoor antenna.

The antenna efficiency is high because there is no lost between the input connector and the cone radiator.

The antenna radiator is extremely broad band. For high frequencies, the antenna radiator is resonated near apex, and for low frequencies the antenna radiator is resonated at the far end of the cone.

### Antenna Enclosure

The FIG. 2 enclosure's outer dimensions are 5¾×5¾×3¼ inch and is formed by bonding several Abs plastic pieces with a 4SC solvent.

Alternatively, the cone element can be enclosed into a plastic cylindrical body such is shown in FIG. 4.

Wood panels may also be used for construction in place of Abs plastics.

### Antenna Coverage Pattern

The antenna pattern coverage of the invention antenna is a broad toroid shape. The axis of the pattern is oriented along the cone axis. The antenna polarization is linear and the field lines are parallel to the cone axis.

It should be noted that one of the important feature of the new art antenna is that the antenna radiation coverage is shaped to radiate on one side of the antenna by a unique thin metal surface bonded to the back sidewall of the enclosure. As a result, the unwanted interference signals resulting from the back side of the antenna are minimized.

1. A new design and fabrication of a high performance compact antenna to receive public airwaves or HDTV signals is disclosed. The invention antenna is composed of a high efficient cone shape broadband element excited over a small metal ground plane via an F connector directly attached from the back side of the small ground plane through the enclosure surface. The design provides extremely broad performance in pattern and impedance. The antenna impedance measurement results show an impedance bandwidth of 10:1 with a return loss greater than 15 db. The antenna size is only 5½×5½×3 inches. The cone angle can be varied from 90 degree to angle smaller or little larger. However, any angle employed differ from 90 degree will alter the physical dimensions of the cone element and its enclosure dimensions. The cone shape radiating element performs equally well in its cubical or cylindrical enclosure. Metal surfaces are used in the antenna enclosure design to help shaping the antenna radiating coverage to minimize reflection effects from surrounding objects.

2. The antenna design of claim 1 has a unique cone shape radiating structure not seen in today's art.

3. The claim 1 antenna is extremely broad band because of the cone radiator and its ground plane design. For high frequencies, the radiator is resonated near the apex, and for low frequencies the radiator is resonated at the far end of the cone.

4. A unique feature of claim 1 employs an F connector which is directly connected to the cone radiator without the use of a coaxial cable.

5. Although the claim 1 antenna is physically small and measures only 5¾×5¾×3¼ inches in size, the antenna can receive more public channels than a larger antenna of 10×10×½ inches aperture.

6. The claim 1 antenna operates well in a weak signal environment and as a result the antenna is able to receive a large number of public channels, greater than 130 stations.

7. The cone radiator of claim 1 antenna is fabricated by forming the cone by joining the edges of a thin metal dish with a portion of the dish cut out. Other method of fabrication such as stamping may also be used.

8. The cone diameter of claim 1 antenna measures 5 inches and the cone angle measures 90 degree. Other angles and diameters may be employed which will alter the physical dimensions of the antenna.

9. The claim 1 antenna cubical enclosure outer dimensions are 5¾×5¾×3¼ inches. It is formed by bonding Abs plastic pieces with a 4SC solvent.

10. Special placement and mounting of the claim 1 antenna is not required.

11. The claim 1 antenna is passive and external power is not required.

12. The claim 1 antenna can be used for transmission and reception of all audio and video signals in the UHF band in close proximity. The design is applicable to other frequencies up to 30 Giga Hertz.

13. The claim 1 antenna design does not require frequency turning or adjustment.

14. The efficiency of the claim 1 antenna is extremely high because there is no losses or signal degradation between the input connector and the cone radiator.

15. The claim 1 antenna in cylindrical enclosure performs equally well as in cubical enclosure. The only difference between the two approaches is their physical appearance. Fabrication simplicity and cost advantage are the important considerations for selection of the enclosure approach.

16. The claim 1 antenna enclosures are new art designs in which metal surfaces are applied to help shaping the antenna radiation coverage to minimize interference signals from the surrounding objects.
